(19) United States
(12) Patent Application Publication
(10) Pub. No.: US 2013/0184037 A1
(43) Pub. Date: Jul. 18, 2013

(54) BASE STATIONS FOR SUPPORTING DEVICES

(71) Applicant: Casey Hopkins, Portland, OR (US)

(72) Inventor: Casey Hopkins, Portland, OR (US)

(21) Appl. No.: 13/740,657

(22) Filed: Jan. 14, 2013

Related U.S. Application Data
(60) Provisional application No. 61/587,564, filed on Jan. 17, 2012.

(51) Int. Cl. H04M 1/11

(52) U.S. Cl. CPC H04M 1/11
USPC 455/575.1

(57) ABSTRACT

Base stations for supporting a device, including a base member defining a cavity and a recess to receive and support the device, the recess including a floor and a back wall, a male plug connector mounted in the cavity in a position extending into the floor of the recess to selectively engage the device when the device is supported in the recess, and an adjustable support system configured to selectively extend to multiple positions in the recess to support the device from one of the multiple positions within the recess. In some examples, the base station includes a track system moveably supporting the male plug connector at multiple distances from the back wall of the recess to support the device in cooperation with the back wall from different positions within the recess.

### CROSS REFERENCE TO RELATED APPLICATIONS

This application claims priority to copending U.S. Application, Ser. No. 61/587,564, filed on Jan. 17, 2012, which is hereby incorporated by reference for all purposes.

### BACKGROUND

The present disclosure relates generally to base stations for supporting devices. In particular, base stations including plug connectors for supporting devices while connected to the plug connector are described. With more particularity, in certain examples, base stations including features to enable a user to readily disengage a device from the base station are described.

Many users find it convenient to use a base station with their electronic devices. A base station, sometimes referred to as a docking station, is designed to support a device. Often, base stations are designed to support a device while the device is connected to a plug connector. Base stations generally support a device in an upright position with a base and include a plug connector supported by the base in a position to engage a device supported by the base.

Known base stations are not entirely satisfactory for the range of applications in which they are employed. For example, existing base stations are prone to devices “sticking” to the base station when a user desires to separate the device from the base station. A common cause for the sticking phenomenon is the male plug connector of the base station sticking not effectively retracting from the female receptacle of the device. The male plug connector not readily retracting from the female receptacle of the device is one example of why it is difficult and cumbersome for a user to disconnect a device from conventional base stations. However, there are other shortcomings of existing base stations as well.

Exacerbating the problems with existing base stations is the fact that conventional base stations are not satisfactorily designed to permit a user to conveniently remove a device docked in the base station. With conventional base stations, a user must generally use two hands to disengage the plug connectors from devices supported by the base stations: one hand to lift the device and the other hand to hold the base station steady. Needing to use two hands is not convenient or desirable. Further, when a user attempts to remove a device from existing base stations, the user is prone to knock over or drop the device, potentially damaging the device.

Further, conventional base stations do not create a sufficiently low center of gravity to inhibit the base station tipping or lifting off the ground when a user attempts to remove the device. Moreover, conventional base stations do not adequately accommodate devices of different dimensions, such as different thicknesses. Indeed, many known base stations are designed to support only a single device and are not configured to adjust to support a variety of devices.

Thus, there exists a need for base stations that improve upon and advance the design of known base stations. Indeed, there exists a need for a base station including a plug connector designed to readily retract from devices. Further, there exists a need for a base station including a low center of gravity to resist tipping and lifting off the ground when a user attempts to disengage a device from the base station. In addition, there exists a need for a base station configured to accommodate devices of different dimensions by adjusting to accommodate one or more dimensions of the device. Examples of new and useful base stations relevant to the needs existing in the field are discussed below.

Disclosure addressing one or more of the identified existing needs is provided in the detailed description below. Examples of references relevant to multi-pin male plug connectors include U.S. Pat. Nos. 5,871,378, 6,485,315, 6,663,406, 6,709,286, 6,796,839, 6,945,824, 6,948,983, 7,160,120, 7,440,287, 7,918,689, 2001/0010983, 2003/0100203, 2003/0129879, 2004/0145875, 2007/0004282, 2007/0141915, 2008/0155824, 2009/0053932. Further relevant to male plug connectors is Inventor's U.S. patent application directed to Readily Disengageable Multi-Pin Male Plug Connectors and filed on Jan. 14, 2013. The complete disclosures of the above patents and patent applications are herein incorporated by reference for all purposes.

Throughout this application, base stations including multi-pin male plug connectors, in particular 30-pin and 9-pin male plug connectors, are described in detail for the sake of brevity and convenience. However, the reader should understand that the teachings described herein may be applied to a wide variety of base stations including plug connectors beyond merely 30-pin or 9-pin male plug connectors.

### SUMMARY

The present disclosure is directed to base stations for supporting a device, including a base member defining a cavity and a recess to receive and support the device, the recess including a floor and a back wall, a male plug connector mounted in the cavity in a position extending into the floor of the recess to selectively engage the device when the device is supported in the recess, and an adjustable support system configured to selectively extend to multiple positions in the recess to support the device from one of the multiple positions within the recess. In some examples, the base station includes a track system moveably supporting the male plug connector at multiple distances from the back wall of the recess to support the device in cooperation with the back wall from different positions within the recess.

### BRIEF DESCRIPTION OF THE DRAWINGS

FIG. 1 is an isometric view of a first example of a base station for supporting a device.

FIG. 2 is an isometric view of the base station of FIG. 1 supporting a device in a recess.

FIG. 3 is front elevation view of the base station of FIG. 1

FIG. 4 is a side elevation view of the base station of FIG. 1.

FIG. 5A is a side elevation cross section view of the base station of FIG. 1 about the line 5-5 in FIG. 1 with a support member in a first orientation.

FIG. 5B is a side elevation cross section view of the base station of FIG. 1 about the line 5-5 in FIG. 1 with the support member in a second orientation.

FIG. 6 is a back elevation view of the base station of FIG. 1.

FIG. 7 is a top plan view of the base station of FIG. 1.

FIG. 8 is a bottom plan view of the base station of FIG. 1.

FIG. 9 is a top view of a second example of a base station including a track mechanism.

### DETAILED DESCRIPTION

The disclosed base stations will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various base stations are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

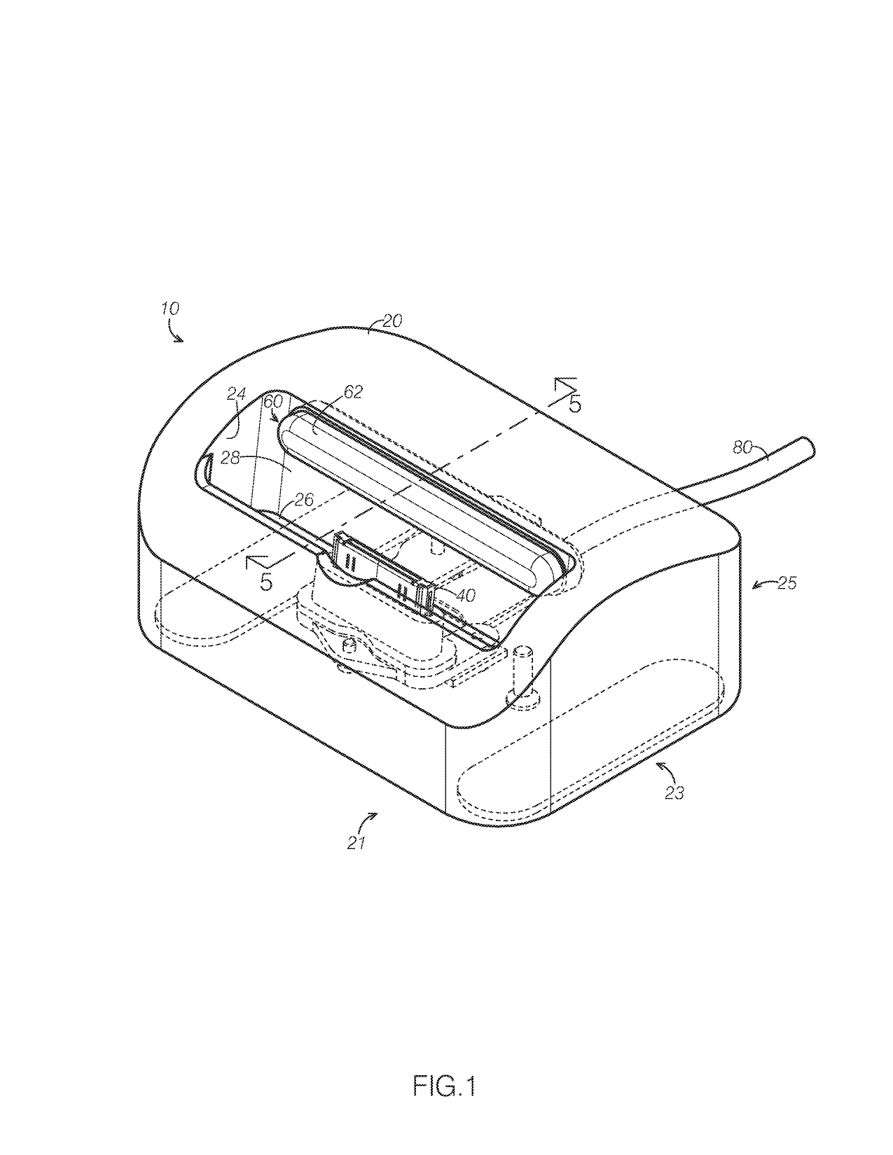

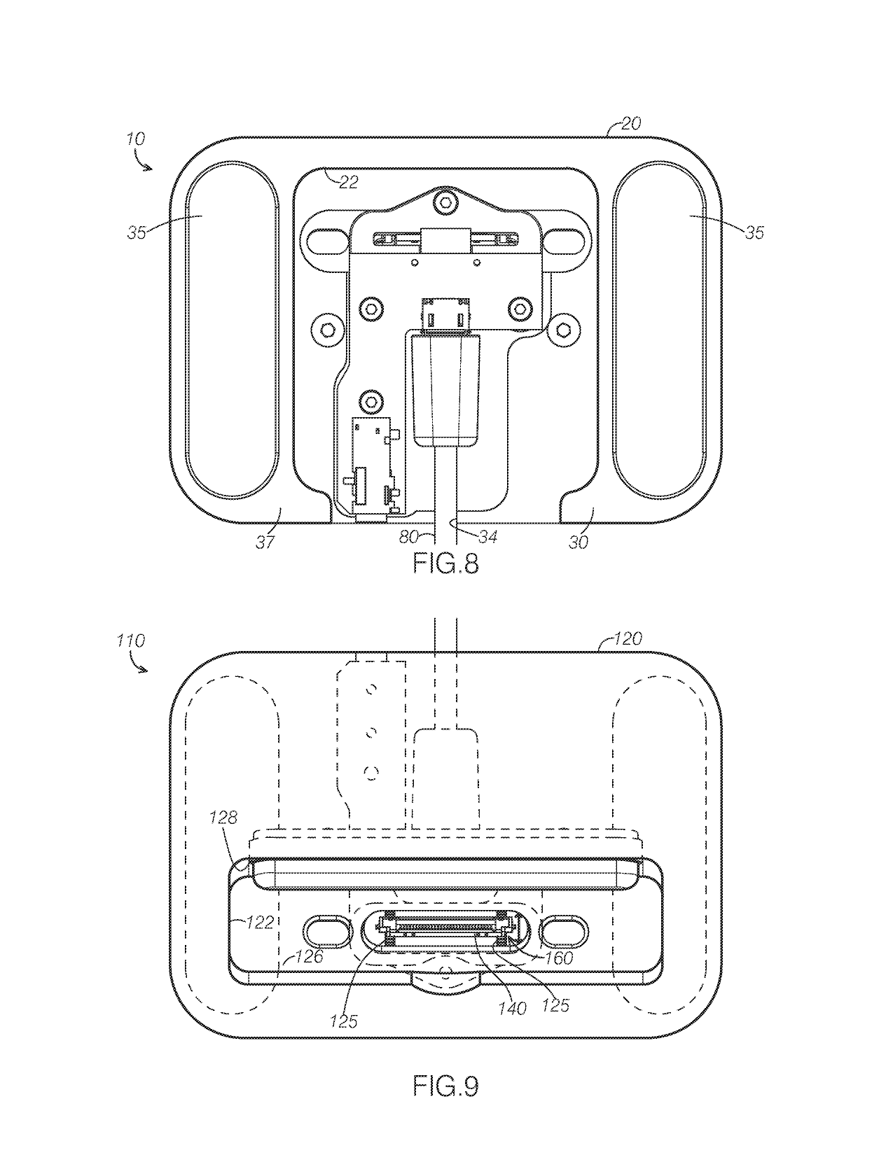

With reference to FIGS. 1-8, a first example of a base station, base station 10, will now be described. Base station 10 includes a base member 20, a male plug connector 40, and an adjustable support system 60. Base station 10 functions to support an electronic device 12 in a position where male plug connector 40 is inserted into device 12.

In particular, base station 10 is configured to enable device 12 to be readily removed from a supported position where device 12 is supported by base member 20 and connected to male plug connector 40. When removed from base station 10, device 12 is in an unsupported position spaced apart from base member 20 and not connected to male plug connector 40. Base station 10 provides a relatively low center of gravity to resist tipping and/or being lifted off of a support surface, such as a desk or table top, when a user seeks to move device 12 from the supported position to the unsupported position. Further, base station 10 is configured to accommodate devices of different dimensions by adjusting adjustable support system 60. The reader will understand that different base station examples discussed herein and in the claims may provide additional or fewer benefits to those just described.

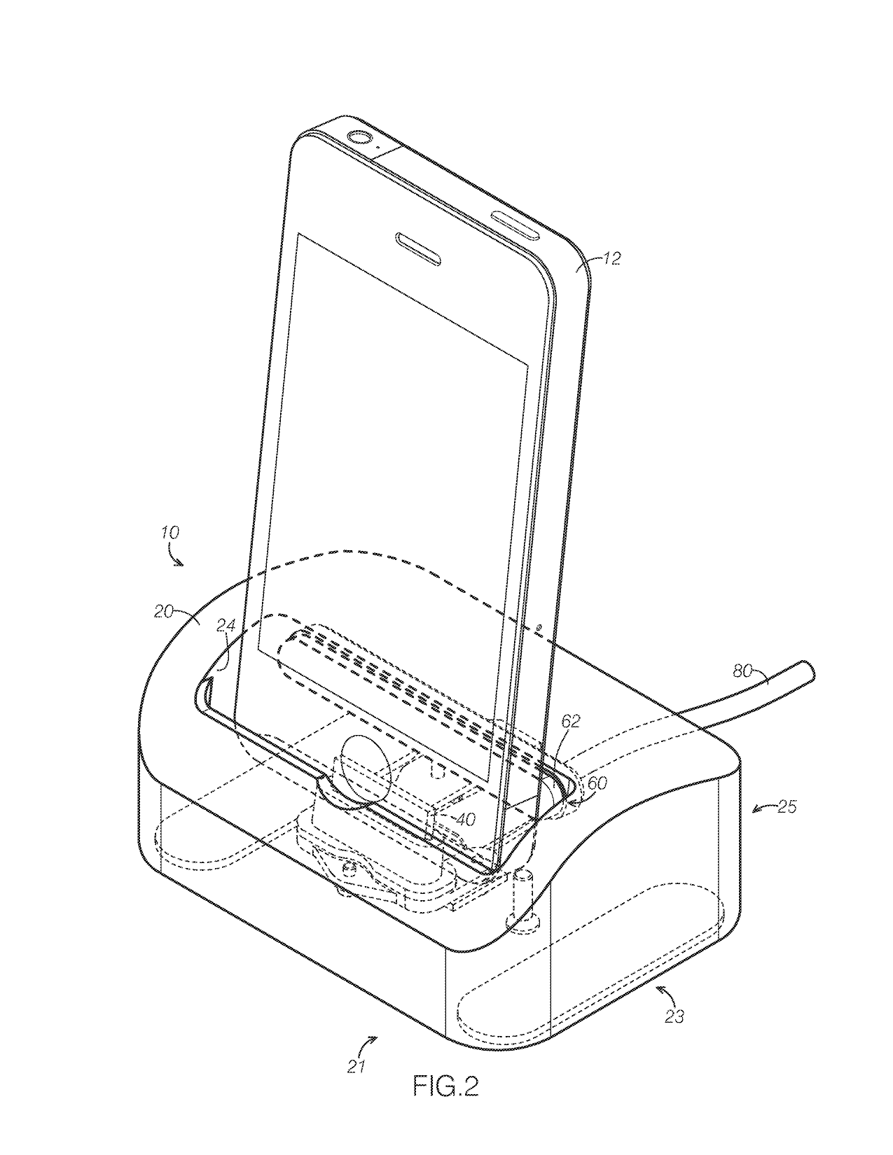

FIG. 2 depicts one example of a suitable device, device 12, to be supported in base station 10. Device 12 is a smart phone, in particular, an iPhone® brand phone. However, base stations described herein may be readily adapted to support other devices, such as a cellular phone, other smart phone brands beyond iPhone® brand phones, such as Android® or Windows® brand smart phones, a personal data assistant, a tablet computer, a notebook computer, and the like.

In the example shown in FIGS. 1-7, base member 20 is composed of solid aluminum. However, in other examples, the base member is composed of other materials, including other metals or metal alloys, plastic, wood, glass, or ceramics. In some examples, such as shown in FIGS. 1-7, the base member is composed of a single material and in other examples it is composed of a combination of materials.

In the example shown in FIGS. 1-7, base member 20 has more mass than the mass of device 12. In the present example, base member 20 is significantly more massive than device 20. In other examples, the base member is more massive than the device by varying degrees.

In still further examples, the base member is of equal or lesser mass than the device. In examples where the device mass is comparable or greater to the mass of the device, the base station will generally include male plug connectors configured to readily disengage from the device. Examples of male plug connectors configured to readily disengage from devices are described below and in the present inventor's copending patent application directed to Readily Disengageable Multi-Pin Male Plug Connectors and filed on Jan. 14, 2013.

Being more massive than device 12, base member 20 resists tipping over when supporting device 12. Further, the mass of base 20 causes it to resist being lifted up or moved horizontally when a user lifts device 12 out of base station 10 and disengages device 12 from male plug connector 40. To further resist base member 20 moving horizontally, base station 10 includes a slip resistant material 35 disposed between base member 20 and the support surface on which base member 20 rests, as shown in FIGS. 1-7.

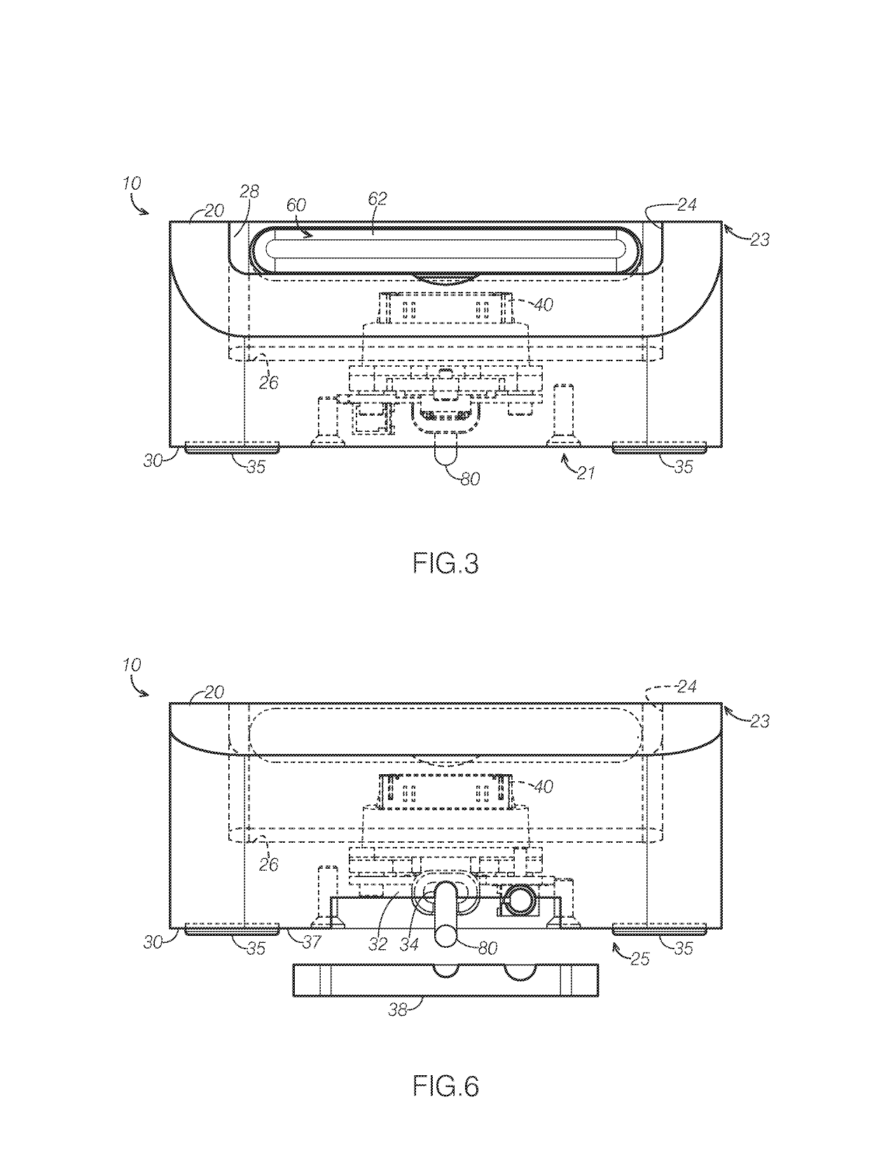

With reference to FIGS. 1-7, base member 20 defines a cavity 22 and a recess 24. As shown perhaps most clearly in FIGS. 3-7, cavity 22 serves to house internal components, such as a portion of male plug connector 40, an interface between cable 12 and male plug connector 40, a printed circuit board, and a secondary data cable connector. The size of the cavity may be varied to accommodate various numbers of components and various types of components of different sizes.

As depicted in FIG. 2, recess 24 is configured to receive and support device 12. With reference to FIGS. 1-8, recess 24 includes a floor 26 and a back wall 28. As shown in FIG. 2, floor 26 is disposed below device 12 and back wall 28 is disposed proximate a back side of device 12 when device 12 is supported in recess 24.

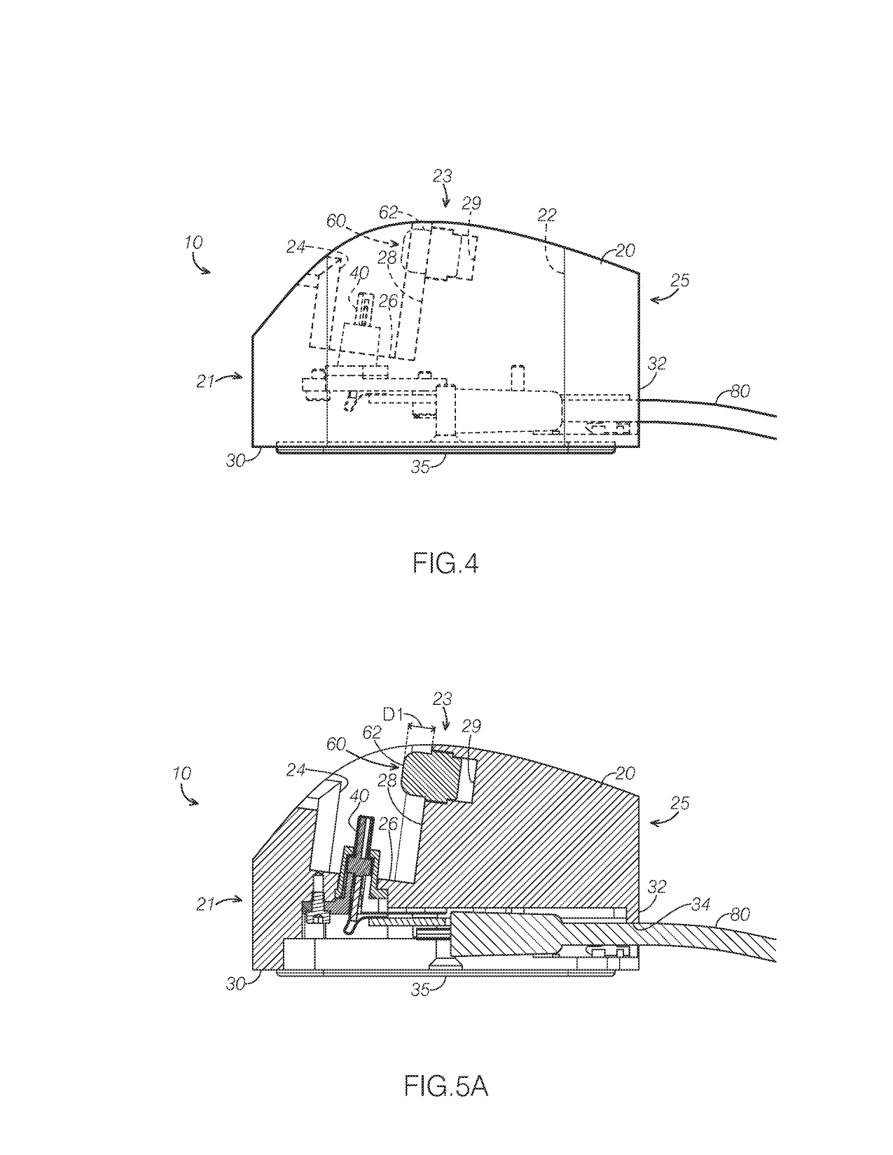

As can be seen in FIGS. 4-7, floor 26 defines an opening 27 extending to cavity 22. Opening 27 defined by floor 26 enables male plug connector 40 to be mounted in cavity 22 and to extend into recess 24. As shown in FIG. 2, device 12 may selectively engage male plug connector 40 in data and/or power communication when device 12 is placed in recess 24.

As shown in FIGS. 1-6, base member 20 includes a front side 21, a rear side 25, and a middle portion 23. Front side 21 is distal the back side of device 12 when device 12 is supported in recess 24 and engaged with male plug connector 40. Rear side 25 is opposite front side 21 and middle portion 23 is disposed between front side 21 and rear side 25. The reader can see in FIGS. 1-6 that middle portion 23 is proximate adjustable support system 60.

In the example shown in FIGS. 1-8, the height of base member 20 is shorter at front side 21 relative to the height of base member 20 at middle portion 23. The reader can see in the figures that the height profile of base member 20 curves upwards from front side 21 to middle portion 23 and curves downward from middle portion 23 to rear side 25.

The height profile of base member 20 reveals more of device 12 when device 12 is viewed from front side 21 of base member 20. Further, the height profile of base 20 supports the backside of device 12 from a higher position than it would with a flat profile. Moreover, the height profile of base 20 disposes most of the mass of base 20 to a relatively low position, giving base 20 a low center of gravity.

With reference to FIG. 6, base member 20 includes a floor portion 30 and a wall portion 32. In the specific example shown in FIGS. 1-8, floor portion 30 includes a fixed portion 37 and a removable cover 38 selectively coupled to fixed portion 37. Removable cover 38 provides access to cavity 22 when cover 38 is removed or separated from floor portion 30 of base member 20.

Floor portion 30 supports base station 10 from a support surface, such as a table top, a desk top, a dresser top, a car dashboard, or the floor. As shown in FIG. 6, slip resistant material 35 is disposed between fixed portion 37 of floor portion 30 and the support surface on which base member 20 rests. The slip resistant material may include any currently known slip resistant material or later developed slip resistant materials.

Wall portion 32 extends up from floor 26 portion and defines a cable port 34 configured to receive and support cable 80. As shown in FIG. 6, wall portion 32 further defines a second port supporting a data socket to which a second cable may connect.

Male plug connector 40 is in data and power communication with cable 80. In turn, cable 80 is in data and power communication with a computing device (not pictured). In the example shown in FIGS. 1-8, male plug connector 40 is configured to selectively insert into a female receptacle of device 12 to enable device 12 to communicate data and power with the computing device.

In some examples, the cable is connected exclusively to a power source, such as a wall outlet, or exclusively to a device configured to communicate data, i.e., to a device that is not configured to also communicate power through the cable. The cable may connect to computers, power sources, such as wall outlets, batteries, etc, other portable devices, such as mp3 players, smart phones, personal data assistance, etc.

Cable 80 is electrically shielded and configured to communicate both data and power. However, any currently known or later developed cable may be used, including shielded and unshielded cables of any suitable gauge and material.

While the figures show one example of a connector, male plug connector 40, the connector may be any currently known or later developed type of connector configured to communicate power and/or data to a device supported by the base member. Suitable examples of connectors are described in Inventor's patent application directed to Readily Disengageable Multi-Pin Male Plug Connectors, filed on Jan. 14, 2013, which is hereby incorporated by reference for all purposes. Additional connector examples include magnetic connectors, universal serial bus connectors, including mini and micro variants of the universal serial bus connector type, hdmi connectors, and the like.

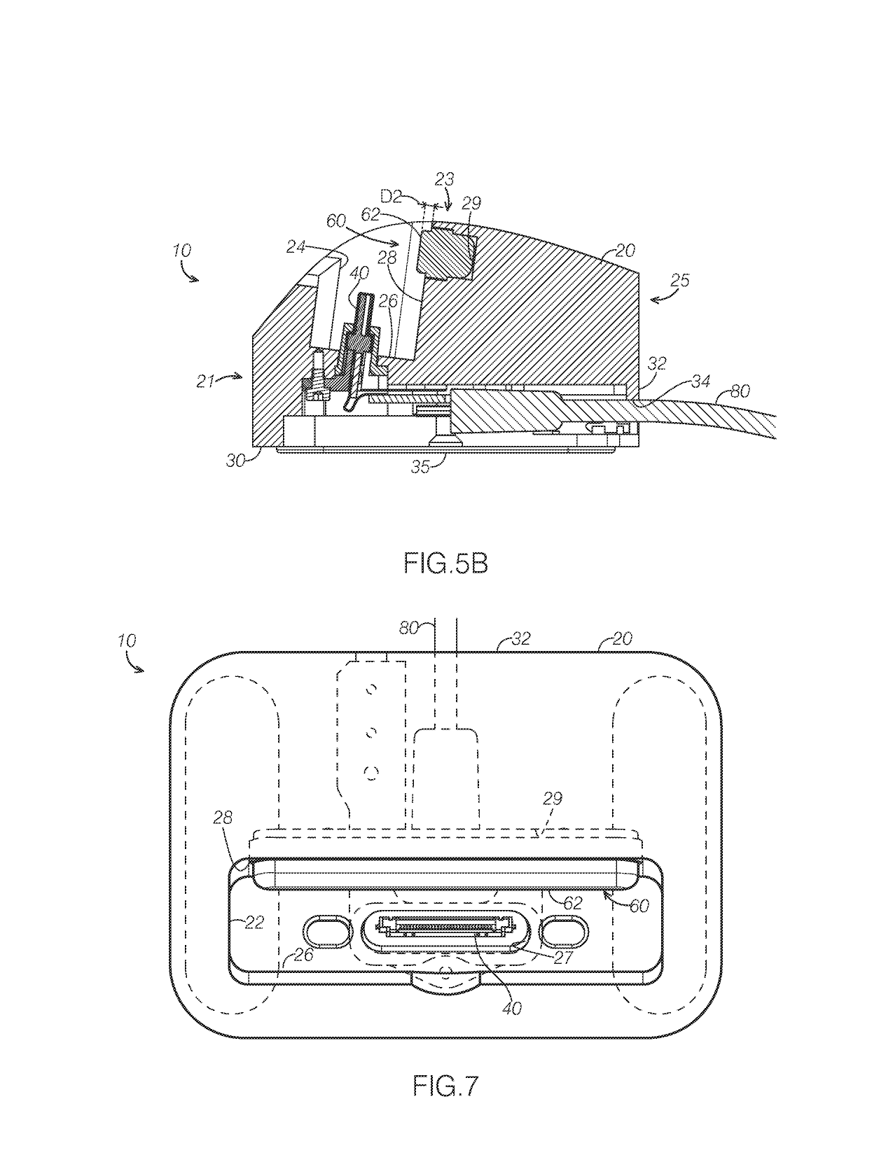

With reference to FIGS. 4-5B, the reader can see that male plug connector 40 is tilted rearward relative to a vertical axis. Male plug connector 40 being mounted at an angle relative to vertical causes it to tilt device 12 toward the back of the recess when device 12 is engaged with plug connector 40. In particular, the tilt of plug connector 40 positions device 12 in a position where the back side of device 12 abuts and is supported by adjustable support system 60.

In the example shown in FIGS. 1-8, adjustable support system 60 is configured to selectively extend to multiple positions in recess 24 to support device 12 from one of the multiple positions within recess 24. With brief reference to FIG. 9, the reader can see an alternative adjustable support system 160, which includes a track system 164.

Returning to FIGS. 1-8, adjustable support system 60 is mounted to back wall 28 of recess 24 and supports device 12 from a back side of device 12 facing back wall 28 of recess 24. In particular, back wall 28 defines a channel 30 and adjustable support system 60 includes a support member 62 configured to insert into channel 30. As shown in FIGS. 5A and 5B, support member 62 is configured to insert into channel 30 in multiple orientations.

In the example shown in FIGS. 1-8, support member 62 is configured to insert into channel 30 in two orientations: a first orientation shown in FIG. 5A and a second orientation shown in FIG. 5B. Comparing FIGS. 5A and 5B, the reader can see that support member 62 in the second orientation is 180 degrees about a longitudinal of support member 62 in the first orientation.

With reference to FIG. 5A, support member 62 extends into recess 24 from back wall 28 a first distance D1 when inserted into channel 30 in the first orientation. With reference to FIG. 5B, support member 62 extends into recess 24 from back wall 28 a second distance D2 that is less than the first distance when it is inserted into channel 30 in the second orientation.

By changing the orientation of support member 62 in channel 30, the user may support device 12 from different distances from back wall 28. Expressed another way, adjustable support system 60 may support devices of different depths by changing the orientation of support member 60 in channel 30. The reader should understand that the user may remove support member 60 from channel 30 and recess altogether and support the device with back wall 28. In this manner, base station 10 may support devices having a wide range of thicknesses.

With reference to FIG. 9, adjustable support system 160 included in base station 110 will be explained in more detail. As shown in FIG. 9, adjustable support system 160 includes track system 164 and a support member. The support member shown in FIG. 9 is substantially similar to support member 62 described above in that it is configured to insert into a channel in multiple orientations or to be removed from the recess altogether. The reader should understand, however, that the support member in FIG. 9 is optional. Indeed, in some examples the base station includes an adjustable support system including only a track system.

As shown in FIG. 9, track system 164 includes two spaced apart tracks 125 supported on a floor 126 of recess 124. Tracks 125 each form longitudinally extending rails and a plurality of longitudinally aligned depressions. The tracks are disposed underneath and on lateral sides of male plug member 140.

Male plug member 140 is configured to slide along tracks 125 when lifted slightly by a user and pushed in the longitudinal direction of tracks 125. As with male plug member 40, male plug member 140 is oriented at an angle tilted from vertical to oriented devices supported by plug member 140 at an angle towards a back wall 128.

When the user has moved male plug member 141 to a desired position along tracks 125 of track system 164, the user may then press plug member 140 towards tracks 125 to rest in a fixed position within the depressions of tracks 125. By moving male plug member 140 closer to or father away from back wall 128 of recess 124 with track system 164, the user may support devices connected to male plug member 140 and having a wide variety of depths. The user may support a device either against back wall 128 or against a support member extending out beyond back wall 128 when utilizing adjustable support system 160 including track system 164.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A base station for supporting a device, comprising:
a base member defining a cavity and a recess to receive and support the device, the recess including a floor and a back wall;
a male plug connector mounted in the cavity in a position extending through an opening in the floor of the recess to selectively engage the device when the device is supported in the recess; and
an adjustable support system configured to selectively extend to multiple positions in the recess to support the device from one of the multiple positions within the recess.

2. The base station of claim 1, wherein the adjustable support system is mounted to the back wall of the recess and supports the device from a back side of the device facing the back wall of the recess.

3. The base station of claim 1, wherein the male plug is mounted in the cavity at an angle to tilt the device towards the back wall of the recess.

4. The base station of claim 1, wherein the back wall defines a channel and the adjustable support system includes a support member configured to insert into the channel.

5. The base station of claim 4, wherein the support member is configured to insert into the channel multiple orientations.

6. The base station of claim 5, wherein the support member is configured to insert into the channel in two orientations, a first orientation and a second orientation 180 degrees about a longitudinal axis of the support member from the first orientation.

7. The base station of claim 6, wherein the support member extends into the recess from the back wall a first distance when inserted into the channel in the first orientation and the support member extends into the recess from the back wall a second distance that is less than the first distance when inserted into the channel in the second orientation.

8. The base station of claim 1, wherein the adjustable support system further includes a track system moveably supporting the male plug connector at multiple distances from the back wall of the recess.

9. The base station of claim 8, wherein the male plug is mounted in the cavity at an angle to tilt the device towards the back wall of the recess and the track system is configured to adjust the male plug connector to a distance from the back wall of the recess where a back side of the device facing the back wall of the recess is supported by the back wall of the recess.

10. The base station of claim 1, wherein the base member is composed of solid aluminum.

11. The base station of claim 1, wherein the base member has more mass than the mass of the device.

12. The base station of claim 1, further comprising an electronically shielded signal cable operatively connected to the male plug connector.

13. The base station of claim 1, wherein the base member includes:
a floor portion supporting the base station from a support surface; and
a wall portion extending up from the floor portion and defining a cable port.

14. The base station of claim 13, wherein the floor portion includes a fixed portion and a removable cover selectively coupled to the fixed portion, the removable cover providing access to the cavity when removed.

15. The base station of claim 14, further comprising a slip resistant material disposed between the fixed portion of the floor portion and the support surface on which the base member rests.

16. The base station of claim 1, wherein the base member includes:
a front side distal the back side of the device when the device is supported in the recess and engaged with the male plug connector;
a rear side opposite the front side; and
a middle portion between the front side and the rear side and proximate the adjustable support system;
where the height of the base member is shorter at the front side relative to the height of the base member at the middle portion to reveal more of the device when the device is viewed from the front side of the base member.

17. The base station of claim 1, further comprising a slip resistant material disposed between the base member and the support surface on which the base member rests.

18. A base station for supporting a device, comprising:
a base member defining a recess to receive and support the device, the recess including a floor and a back wall defining a channel;
a male plug connector mounted to the base member in a position extending into the floor of the recess to selectively engage the device when the device is supported in the recess; and
a support member configured to insert into the channel in different orientations to selectively extend to different positions relative to the back wall of the recess to support the device from different positions within the recess.

19. The base member of claim 18, wherein the support member extends into the recess from the back wall a first distance when inserted into the channel in a first orientation and the support member extends into the recess from the back wall a second distance that is less than the first distance when inserted into the channel in a second orientation.

20. A base station for supporting a device, comprising:
a base member defining a recess to receive and support the device, the recess including a floor and a back wall;
a male plug connector mounted to the base member in a position extending into the floor of the recess to selectively engage the device when the device is supported in the recess; and
a track system moveably supporting the male plug connector at multiple distances from the back wall of the recess to support the device in cooperation with the back wall from different positions within the recess.
